(19) United States
(12) Patent Application Publication
(10) Pub. No.: US 2023/0066390 A1
(43) Pub. Date: Mar. 2, 2023

(54) H2S SUPPRESSION AND MANAGEMENT IN SULFIDE-BASED SOLID-STATE BATTERIES

(71) Applicant: FORD GLOBAL TECHNOLOGIES, LLC, Dearborn, MI (US)

(72) Inventors: Asma Sharafi, Ann Arbor, MI (US); Andrew Robert Drews, Ann Arbor, MI (US); Venkataramani Anandan, Farmington Hills, MI (US)

(21) Appl. No.: 17/462,693

(22) Filed: Aug. 31, 2021

(51) Int. Cl. H01M 10/52; H01M 10/36; H01M 50/119; H01M 50/124

(52) U.S. Cl. CPC H01M 10/52; H01M 10/36; H01M 50/119; H01M 50/1243

(57) ABSTRACT

Electrochemical systems for mitigating or reducing the release of undesirable by-products of electrochemical cells are provided. These systems may be particularly relevant to the sequestering of hydrogen sulfide gas in solid state electrochemical cells with sulfide-based electrolytes. Some of the systems include an integrated hydrogen sulfide eliminating layer or microspheres containing a hydrogen sulfide eliminating material adjacent to one or more electrochemical cells and within a containment structure.

### TECHNICAL FIELD

The present disclosure relates to systems and methods of managing or suppressing the release of undesirable emission from electrochemical cells. More specifically, the present disclosure relates to managing hydrogen sulfide gas (H₂S) emission in sulfide-based solid-state batteries.

### BACKGROUND

Advances to reduce dependence on fossil fuels and use other energy sources are underway. However, many of these efforts require or rely on the storage of the energy sourced from the other methods. Electrochemical cells such as batteries are a primary method of storing such energy. These technologies may be particularly relevant to the electrical vehicle (EV) market. Sulfide-based batteries show great promise because they may have high energy densities, greater durability, and longer life cycles. However, sulfide-based materials such as sulfide-based electrolytes have the major drawback of sensitivity to moisture such as in the air. These materials often generate H₂S gas when exposed to moisture. Although the electrolyte material may be produced under moisture-controlled environments, actual applications may require venting to the external environment and/or limiting moisture (e.g., humidity) exposure over time may be difficult or impractical.

### SUMMARY

An electrochemical system is provided. The electrochemical system includes a containment structure, one or more electrochemical cells with a sulfide-based material in the containment structure, and an integrated hydrogen sulfide eliminating layer or microspheres containing a hydrogen eliminating material (HEM) that are adjacent to the one or more electrochemical cells.

In another embodiment, an electrochemical system having a containment structure, one or more electrochemical cells in the containment structure and a reagent bed is provided. The one or more electrochemical cells include a sulfide-based material, and the reagent bed has a hydrogen sulfide eliminating material.

In yet another embodiment, an electrochemical system including a containment structure housing one or more electrochemical cells and having a hydrogen sulfide eliminating layer and a reagent bed including a hydrogen sulfide eliminating material is provided.

### BRIEF DESCRIPTION OF THE DRAWINGS

FIG. 1A is an electrochemical system.

FIG. 1B is an exploded view of an electrochemical system.

FIG. 2A is an electrochemical cell, FIG. 2B is an electrochemical array, and FIG. 2C is an electrochemical pack.

FIG. 3 is schematic of an electrochemical pack system with a separate reagent bed.

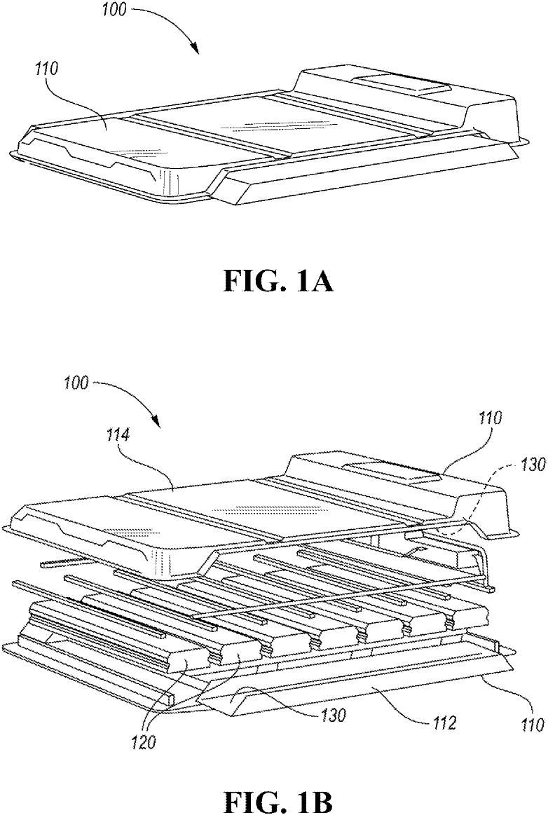

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for given purpose implies the mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 ... 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

An electrochemical system is provided. The electrochemical system 100 includes a containment structure 110, one or more electrochemical cells 120 in the containment structure 110 and a sequestering layer 130 adjacent to the one or more electrochemical cells 120 and within the containment structure 110. For example, the sequestering layer 130 may be a layer including a hydrogen sulfide eliminating material (HEM). The sequestering layer 130 may now be described and referred to as a HEM layer or hydrogen sulfide eliminating layer. Upon release of hydrogen sulfide (H₂S) gas the HEM layer reacts with or adsorbs the hydrogen sulfide gas.

Containment structure 110 is not particularly limited but should house the one or more electrochemical cells 120. The containment structure 110 may be vented or may act as a barrier (e.g., hermetically sealed) separating the electrochemical environment from the external environment. An unvented structure may be possible with a solid-state electrochemical cell. An unvented structure may be preferred when a sulfide-based electrolyte is used to reduce exposure to moisture and the thus production of hydrogen sulfide. The containment structure 110 may also provide support for the various components of the electrochemical system 100 such as pouch cells. The containment structure 110 may provide protection. In one variation, containment structure 110 may include a pack tray 112 for supporting and holding the one or more electrochemical cells 120 and a cover 114 for housing the one or more electrochemical cells 120. The containment structure 120 and/or pack tray 112 and cover 114 may have greater surface areas than other portions or components of the electrochemical system which may make them particularly suitable for a HEM such as a coating or layer.

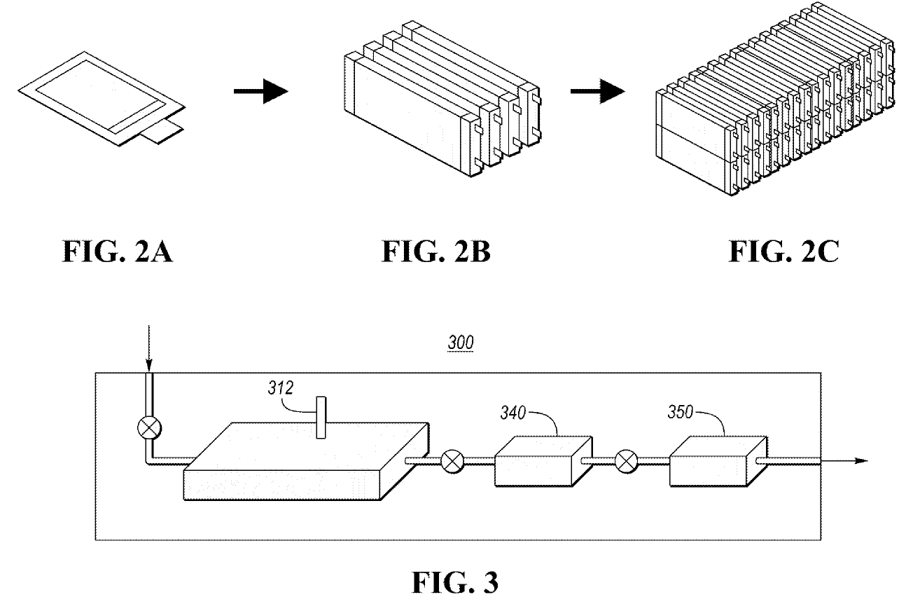

The one or more electrochemical cells 120 may be a single electrochemical cell, an electrochemical cell array (e.g., 2 to 50 cells), or an electrochemical cell pack (e.g., 2 to 50 arrays) as shown in FIGS. 2A-C. An electrochemical cell includes a plurality of electrodes (e.g., an anode and cathode) and an electrolyte. The electrochemical cell is not particularly limited and may be any configuration generating electrical energy from chemical reactions. For example, cylindrical, pouch or prismatic cells may be used. The one or more electrochemical cells 120 include a sulfide-based material that may be sensitive to water or react to produce hydrogen sulfide gas. The sulfide-based material may be one or more of a sulfide-based solid-state electrolyte (SSE), a sulfide-polymer blend SSE, a sulfide-based active material in and/or on an electrode, or a sulfide-based catholyte or anolyte in and/or on an electrode composite. For example, a solid polymer electrolyte or solid-state electrolyte such as a sulfide-based polymer electrolyte may be used. The sulfide-based polymer electrolyte may be sensitive to water or react with water at room temperature and/or operating temperatures (e.g., 25° C. or 80° C.) thus producing hydrogen sulfide gas. In another example, a sulfide-based active material in and/or on the cathode of a lithium-ion battery may be used and react to produce hydrogen sulfide gas.

Sequestering layer 130 is configured to react with and/or adsorb and retain undesirable materials such as hydrogen sulfide gas and/or water. For example, the sequestering layer 130 may be a hydrogen sulfide eliminating layer that sequesters hydrogen sulfide or sulfur upon release of hydrogen sulfide from the one or more electrochemical cells 120. The sequestering layer 130 and the following disclosure may be described in context of hydrogen sulfide (i.e., an undesirable byproduct), a hydrogen sulfide eliminating layer (i.e., the sequestering layer 130), and a sulfide-based electrolyte (i.e., a byproduct producing material such as, for example, a sulfide-based material). However, it should be understood, and the disclosure is not particularly limited to hydrogen sulfide or sulfur and the sequestering material thereof but instead embraces any material that sequesters an undesirable composition or by-product such as gas. The hydrogen sulfide eliminating layer is preferably between the containment structure 110 and the one or more electrochemical cells 120. However, the hydrogen sulfide eliminating layer may alternatively or also be between electrochemical cells or arrays. The hydrogen sulfide eliminating layer may be a discontinuous material such as powder or microspheres or a continuous material (i.e., integrated) such as a foam, coating, or sheet. The hydrogen sulfide eliminating layer includes a hydrogen sulfide eliminating material (HEM). The hydrogen sulfide eliminating material may be integrated or mixed into the foam, coating, or sheet. Alternatively, the HEM may be applied or positioned within the containment structure 110 as a powder, film, foam, coating or sheet. The HEM may also be provided in microspheres that are designed to release the HEM above specific pressures such as 1,000 PSI, more preferably 5,000 PSI or even more preferably 8,000 PSI. The use of microspheres may isolate or hold the HEM until certain events occur. This event may likely cause the release of hydrogen sulfide and the hydrogen sulfide eliminating material approximately simultaneously.

The foam or coating may be applied to any portion of the electrochemical system 100 but portions with larger surface areas such as the inside of tray 112 or cover 114 may provide greater efficiency because they have relatively large surface areas compared with many of the other components of the system 100. However, the foam or coating may alternatively or also be applied to the electrochemical cells, cell arrays (i.e., modules) or cell packs. Similarly, individual components of the cells may be coated, such as the cell packing (e.g., the pouch). However, if the foam or coating comes in direct contact with the components of any electrochemical component it preferably does not interfere with the electrochemical reaction and is stable in that environment. If a foam is used it may be injected into containment structure 110 after its assembly. A space filling foam may be used for occupying empty space within the electrochemical system 100. An open cell foam may be preferable because of its larger surface area. A space filling foam may also have the additional benefit of holding the components of the system in place and being light weight.

A sheet including the HEM may also be used as the hydrogen eliminating layer and may be used to wrap individual cells, arrays, or packs. Additionally, or alternatively, sheets may be placed between electrochemical cells, arrays, or packs. Again additionally, or alternatively, sheets may be positioned between the containment structure 110 and the one or more electrochemical cells 120. HEM containing sheets may be particularly relevant because they can replace inert sheets already used in the preparation of some electrochemical systems for wrapping cells, cell arrays or packs. A porous sheet or coating may be preferable as this increases the surface area and desirable interaction.

The foam, coating, sheet or microspheres are not particularly limited in their composition but preferably are inert or non-reactive and non-corrosive to the one or more electrochemical cells 120. The hydrogen sulfide eliminating layer is preferably flexible (e.g., young’s modulus of less than 25 GPa, more preferably less than 10 GPa, or even more preferably less than 5 GPa) and electrically insulating (e.g., greater than 10 ohms, more preferably greater than 10⁵ ohms, or even more preferably greater than 10¹⁵). The foam, coating, or sheet may be formed from a formulation that may include a polymer and/or monomers capable of forming a polymer. Certain polymers and/or additives such as but not limited to polyethylene, polyvinyl chloride, Teflon, and silicone may be used in the formulation of the foam, coating or sheet to provide flexibility or electrical insulation. Electrical insulation may be particularly relevant if the hydrogen sulfide eliminating layer is in direct contact with the one or more electrochemical cells 120. It should be understood that the use of a foam, coating and sheet are not exclusive and may be used in various combination with each other.

HEMs may operate by reacting with hydrogen sulfide to produce more favorable by-products (i.e., reactive HEMs) or HEMs may operate through adsorption and retention of hydrogen sulfide. Both types of HEMs may or may not be regenerated such as by but not limited to heating or purging which may reverse the reaction or remove the adsorbed hydrogen sulfide under controlled conditions. Once the HEM is cleansed or regenerated it may be suitable for or more effective at reacting with or sequestering hydrogen sulfide, sulfur and/or water. Regeneration may also remove other materials that may saturate or adsorb to the HEM material making them less effective such as water and/or CO₂.

Reactive HEMs may include but are not limited to metal oxide, metal hydroxides, metal halides, and/or carbonates. Suitable reactive HEMs may be sodium hydroxide (NaOH), ferrous chloride (FeCl₃), iron oxide-hydroxide (FeO(OH)), iron hydroxide (Fe(OH)₃), iron oxide (Fe₂O₃) potassium permanganate (KMnO₄), sodium bicarbonate (Na₂CO₃), ZnO, CuO, In₂O₃, NiO, Al₂O₃, Cr₂O₃, MnO, hydrates and combination thereof. For example, the following formula represent reactions that may occur with hydrogen sulfide (H₂S). For sodium hydroxide:

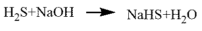

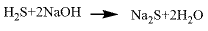

For ferrous chloride:

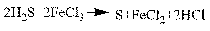

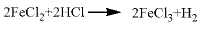

The FeCl₂ of formula (3) may be regenerated back to FeCl₃ after sulfur is removed by electrochemical oxidation.

For iron oxide-hydroxide, the reaction may be used to deposit sulfur on the hydrogen sulfide eliminating layer by substituting the oxygen with sulfur (i.e., Fe—O to Fe—S).

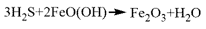

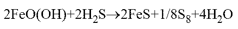

Iron hydroxide and (α- or _{Y}-) iron oxide may be particularly useful because they can be regenerated at low temperature in the presence of air.

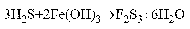

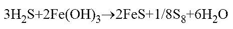

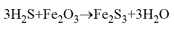

Regeneration reactions for the various ferrous materials are shown below.

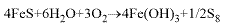

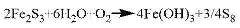

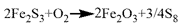

Potassium permanganate may be particularly effective because the byproduct (MnO₂) of formulas (13) and (14) may likewise sequester sulfur by further reaction with hydrogen sulfide.

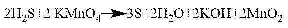

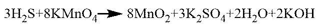

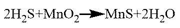

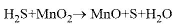

Sodium bicarbonate likewise has a by-product (NaHCO₃) that further reacts with hydrogen sulfide. Sodium bicarbonate is also useful because the final by-products may be released into the environment.

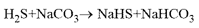

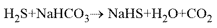

Various metal oxides may also be used. Metal oxide or metal oxide combinations may be the most effective at removing hydrogen sulfide.

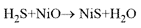

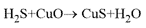

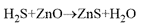

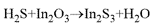

Adsorption HEMs operate by capturing and retaining hydrogen sulfide via physisorption or chemisorpotion. They include but are not limited to metal organic frameworks (MOFs), activated carbon, zeolites, and molecular sieves. Materials with weaker reaction sites may be preferable because they can more easily be regenerated. Some of these material such as molecular sieves and ultra-hydrophilic porous carbon may have the dual purpose of sequestering water to prevent the formation of hydrogen sulfide and sequestering hydrogen sulfide if it is created. HEMs rely on surface interactions and thus are more effective if they have a greater surface area. Thus, increasing the surface area may provide more effective mitigation of hydrogen sulfide releases. For example, smaller particle sizes may make the HEM material more effective. For example, a particle size of no more than 50 µm, or more preferably no more than 1 µm, or even more preferably 100 nm may be used. Similarly, using porous structures or porous microstructures for both the HEM and the hydrogen sulfide eliminating layer may improve the effectiveness. Blowing agents for example may increase porosity. In a refinement, the porous structures may have a high pore volume of at least 0.05 cm³/g, or more preferably 0.1 cm³/g, or even more preferably 0.15 cm³/g per ASTM D4408-18. In another variation, the porous structure has a porosity of at least 10%, more preferably greater than 25% or even more preferably greater than 50 % per ISO4590:2002.

In yet another embodiment, electrochemical system 300 includes a containment structure 310 housing one or more electrochemical cells 320 and a reagent bed 340 in communication with the containment structure 310. The electrochemical cell may further include an exhaust fan 350 for ensuring undesirable gases flow through or to the reagent bed upon detection of hydrogen sulfide or a certain event. The exhaust fan 350 may be actuated upon release of hydrogen sulfide gas or upon a certain event. The exhaust fan 350 may be powered by an external power source such that it operates when the electrochemical system is inoperable. For example, the external power source may be a low voltage or high voltage system of a vehicle or an independent battery such as a low-energy long-life battery. An active exhaust system may assist in preventing pressure build ups.

The reagent bed 340 includes a HEM for reducing the release of hydrogen sulfide. The reagent bed 340 may be in the containment structure 310. However, it may preferably be separate from the containment structure 310, so the containment structure 310 does not need to be redesigned. The reagent bed 340 may be configured for fluid communication with the containment structure 310 so that hydrogen sulfide released from the one or more electrochemical cells 320 may flow to the reagent bed 340. For example, fluid communication may be facilitated by an orifice between the two adjacent chambers or a hollow structure (e.g., pipe, duct, hose) between the containment structure 310 and reagent bed 340 that connects the two together. Passive or active operation of this system may be employed.

A passive system may allow any leaked hydrogen sulfide, even small and/or continuous leaks, to be handled. However, passive systems may be open to the external environment and thus tolerant of ambient air and humidity. These systems also avoid pressure build up as they are open to the external environment. For example, in a passive system gas may freely flow between the containment structure 310 and reagent bed 340.

An active system may be more effective for certain events because they do not experience continual use or exposure to the external environment, but less effective for small and/or continuous releases. In an active system, valves may be employed and configured to selectively allow fluid communication upon release of hydrogen sulfide or a certain event (i.e., triggering event). For example, the electrochemical system 300 may include a sensor 312 that detects hydrogen sulfide or changes in pressure such that one or more valves is opened to direct hydrogen sulfide to the reagent bed 340 during or after the triggering event. For example, the valve(s) may be triggered by the sensor 312 that detects a defect, malfunction, or sudden contact. For instance, a sudden contact sensor may be used.

Pressure-release valves may also be used to open the flow path or release gas from the containment structure 310 to the reagent bed 340 upon occurrence of a triggering event (i.e., a contact event or significant change in pressure). A pressure-burst membrane may be a type of valve suitable for more passive valve-like operation. The membrane isolates the reagent bed during operation but bursts upon a high-pressure event thus opening the flow path between the containment structure 310, reagent bed 340 and/or external environment. The valves and/or membranes may release when at a pressure of at least 500 PSI is experienced, more preferably at least 1,000 PSI, or even more preferably at least 2,500 PSI. The containment structure 310 and reagent bed 340 may also have one or more valves controlling exposure to the external environment. These valves may likewise open upon detection of hydrogen sulfide or via a change in pressure. The fan 350 may also be included and positioned in-line with the reagent bed 340 such that the fan induces air (gaseous) flow from the containment structure 310 to reagent bed 340.

The reagent bed 340 may be removeable such that it can be replaced and/or regenerated. Regeneration or replacement may be particularly relevant to a passive system that is open to the containment structure 310 and/or external environment. However, the reagent bed does not necessarily need to be removed for regeneration. For example, heat from the electrochemical system may regenerate the reagent bed. It should be understood that the hydrogen sulfide eliminating layer and reagent bed are not necessarily mutually exclusive embodiments but may be combined. For example, a hydrogen sulfide eliminating layer may be used to mitigate or prevent small releases of hydrogen sulfide and a reagent bed may be reserved for significant or catastrophic events.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An electrochemical system comprising:
a containment structure;
one or more electrochemical cells in the containment structure, the one or more electrochemical cells having a sulfide-based material; and
an integrated hydrogen sulfide eliminating layer or microspheres containing a hydrogen sulfide eliminating material adjacent to the one or more electrochemical cells and within the containment structure, the hydrogen sulfide eliminating layer or material including FeC1₃, FeO(OH), KMnO₄, Na₂C0₃, Fe₂O₃, Fe(OH)₃, ZnO, CuO, NiO, A1₂0₃, metal organic frameworks, molecular sieves, or combinations thereof.

2. The electrochemical system of claim 1, wherein the integrated hydrogen sulfide eliminating layer is present and is a sheet including a hydrogen sulfide eliminating material.

3. The electrochemical system of claim 2, wherein the sheet is wrapped around at least one of the electrochemical cells.

4. The electrochemical system of claim 1, wherein the integrated hydrogen sulfide eliminating layer is present and is a space filling foam including a hydrogen sulfide eliminating material.

5. The electrochemical system of claim 1, wherein the containment structure includes a pack tray and a cover, and the integrated hydrogen sulfide eliminating layer is present and coated on the inside of the pack tray and cover.

6. The electrochemical system of claim 1, wherein the one or more electrochemical cells is a plurality of cells and the integrated hydrogen sulfide eliminating layer is present as sheets between the cells.

7. The electrochemical system of claim 1, wherein the integrated hydrogen sulfide eliminating layer is present and is configured to react with hydrogen sulfide.

8. The electrochemical system of claim 1, wherein the integrated hydrogen sulfide eliminating layer is present and is configured to adsorb hydrogen sulfide.

9. (canceled)

10. An electrochemical system comprising:
a containment structure;
one or more electrochemical cells within the containment structure, the one or more electrochemical cells having a sulfide-based material;
a sensor to detect the presence of hydrogen sulfide or changes in pressure; and
a reagent bed having a hydrogen sulfide eliminating material therein.

11. The electrochemical system of claim 10, wherein the reagent bed is within the containment structure.

12. The electrochemical system of claim 10, wherein the reagent bed is separate from the containment structure and in fluid communication with the containment structure.

13. The electrochemical system of claim 12, wherein the reagent bed is in selective communication with the containment structure, and the selective communication is controlled by a first valve.

14. The electrochemical system of claim 13, wherein the first valve includes a pressure-burst membrane.

15. The electrochemical system of claim 12, wherein the reagent bed includes a second valve for selective communication with an external environment.

16. The electrochemical system of claim 10, wherein the hydrogen sulfide eliminating material is configured to react with hydrogen sulfide.

17. The electrochemical system of claim 10, wherein the hydrogen sulfide eliminating material is configured to adsorb hydrogen sulfide.

18. The electrochemical system of claim 10, wherein the hydrogen sulfide eliminating material includes FeC1₃, FeO(OH), KMnO₄, Na₂CO₃, Fe₂O₃, Fe(OH)₃, ZnO, CuO, NiO, A1₂O₃, metal organic frameworks, activated carbon, porous carbon, molecular sieves, or combinations thereof.

19. The electrochemical system of claim 12, further including an exhaust fan configured to actuate upon a triggering event and move gas from the containment structure to the reagent bed.

20. An electrochemical system comprising:
a containment structure;
a plurality of electrochemical cells within the containment structure, the one or more electrochemical cells having a sulfide-based material;
a-one or more hydrogen sulfide eliminating layer-sheets within the containment structure and wrapped around each cell such that one or more of the sheets is disposed between electrochemical cells and
a reagent bed including a hydrogen sulfide eliminating material.
